(19) United States
(12) Patent Application Publication
(10) Pub. No.: US 2025/0032828 A1
(43) Pub. Date: Jan. 30, 2025

(54) HIGH-FLOW EMBER SHIELD BUILDING VENTILATOR

(71) Applicant: Noll/Norwesco LLC, Fife, WA (US)

(72) Inventors: David Starr, Vashon, WA (US); Joseph Zenkus, Fife, WA (US)

(73) Assignee: Noll/Norwesco LLC, Fife, WA (US)

(21) Appl. No.: 18/795,266

(22) Filed: Aug. 6, 2024

Related U.S. Application Data
(63) Continuation-in-part of application No. 17/534,501, filed on Nov. 24, 2021, now Pat. No. 12,055,313.
(60) Provisional application No. 63/125,090, filed on Dec. 14, 2020.

(51) Int. Cl. A62C 2/06; F24F 7/02

(52) U.S. Cl. CPC A62C 2/06; F24F 7/02

(57) ABSTRACT

A high-flow ember shield building ventilator for use with roof or attic exhaust systems has a substantially rectangular outer frame portion with four side walls and a bottom wall, and a folded screen insert inserted into an opening of the frame portion. A cylindrical frame having a screen installed thereon is mounted onto the rectangular frame portion over the folded metal insert. A high-flow ember shield alternatively has a cylindrical frame with a screen insert formed by concentric rings of mesh material.

### CLAIM OF PRIORITY

This continuation in part application claims priority to U.S. patent application Ser. No. 17/534,501 filed on Nov. 24, 2021, which claims priority to Provisional Patent Application 63/125,190 filed Dec. 14, 2020, the entire contents of each are incorporated herein by reference.

### BACKGROUND OF THE DISCLOSURE

Ventilation is required in most building structures to induce air flow across the under side of structure interior surfaces (typically floor and roof membranes) reducing potential for condensation, mold, or structure deterioration as well as cooling attic spaces, warming crawl and basement spaces, improving isolation performance and overall interior space comfort. Net free area (NFA) is the sum total area of openings allowing air to penetrate into the interior and a method of measuring effectiveness or specification for static ventilation.

Static ventilation works on principals of thermodynamics where delta air temperature inside space and outside create natural convection between intake and exhaust vents. When a structure is subjected to fire, the superheated air outside tends to supercharge the convection process forcing hot embers to flow into interior vented space leading to structure fires. The recent increased frequency and intensity of wild-fires have caused building code requirements to evolve to block hot embers from being sucked into building structures through static vents. Typical specifications have reduced the maximum opening size of screen, or wire mesh openings to be ⅛″ or less in any direction. This greatly reduces the net free area on most existing ventilation designs. While multiple additional ventilators can be installed to meet original NFA targets, a solution allowing original quantity of vents maintaining net free area is desired.

The present invention addresses these problems by forming the screen into three dimensional shapes allows for significantly greater amount of screen to be installed in same original opening and allowing for total net free area of openings to be equal to original specifications while blocking passage to small airborne particles like glowing embers from a forest fire. Structure safety is increased by maintaining net free area and blocking smoldering embers.

Another application for the vent and the shield is for attic exhaust fans and vents. Accordingly, there is a need for an ember vent and shield which overcomes the above mentioned difficulties and others while providing better overall results.

### SUMMARY OF THE DISCLOSURE

The disclosure relates to screen and ventilation and exhaust systems. More plurality, that relates to high flow ember shield ventilators systems for roof or attics as well as basements or foundations.

According to one aspect of the present disclosure, a high-flow ember shield building ventilator is provided comprising a substantially trapezoidal outer frame portion with a long side, a short side, a substantially vertical front side and opposing angled sides; wherein the long side has a first long side end and a second long side end, the short side has a first short side end and a second short side end, the substantially vertical front side has a first substantially vertical front side end and a second substantially vertical front side end and the angled side has a first angled side end and a second angled side end.

According to another aspect of the present disclosure, a high-flow ember shield building ventilator is provided with a substantially trapezoidal outer frame portion with a long side, a short side, a substantially vertical front side and opposing angled sides and a folded metal insert. The long side has a first long side end and a second long side end, the short side has a first short side end and a second short side end, the substantially vertical front side has a first substantially vertical front side end and a second substantially vertical front side end, the angled side has a first angled side end and a second angled side end and the folded metal insert is between the first angled side end and the second angled side end.

In accordance with another aspect of the disclosure, a high-flow ember shield building ventilator for use with roof or attic exhaust openings, includes a substantially rectangular outer frame portion with four side walls and a bottom wall, a folded screen insert inserted into an opening of the frame portion formed by the side walls and the bottom wall, a cylindrical frame having a screen installed thereon, wherein the cylindrical frame and the screen are mounted into the rectangular frame portion over the folded metal insert.

In accordance with another aspect of the disclosure, a high-flow ember shield configuration for use in a roof or attic exhaust, has: a cylindrical frame, a screen insert formed of concentric rings of mesh, wherein said screen is inserted into the cylindrical frame for preventing embers and other debris entering an exhaust ventilation system.

Still another aspects of the disclosure will become apparent upon a reading and understanding of the following description.

### BRIEF DESCRIPTION OF THE DRAWINGS

FIG. 1 is a front elevational view of a prior art square ember shield design.

FIG. 2 is another first elevational view of prior art square ember shield design.

FIG. 3 is a side elevational view of a prior art square ember shield design.

FIG. 4 is a side elevational view of a high flow ember shield in accordance with a preferred embodiment of the disclosure.

FIG. 5 is a side elevational view of the flow ember shield of FIG. 4.

FIG. 6 is another side elevational view of the high flow ember shield of FIG. 4.

FIG. 7 is another side elevational view of the high flow ember shield of FIG. 4.

FIG. 8 is another side elevational view of the high flow square ember shield design.

FIG. 9 is a cross-sectional view there along section A-A of FIG. 5.

FIG. 10 is a cross-sectional view of the high flow ember shield of FIG. 9.

FIG. 11 is a front perspective view of the high flow ember shield.

FIG. 12 is a rear perspective view of the high flow ember shield.

FIG. 13 is a front elevational view of the high flow ember shield.

FIG. 14 is another front elevational view of the high flow ember shield.

FIG. 15 is a side elevational view of the high flow ember shield.

FIG. 16 is another side elevational view of the high flow ember shield.

FIG. 17 is a rear elevational view of the high flow ember shield.

FIG. 18 is a front elevational view of the high flow ember shield.

FIG. 19 is a top perspective view of a high flow ember shield vent and enclosure in accordance with another aspect of the disclosure.

FIG. 19A is a cross-sectional view of the vent screen of FIG. 19.

FIG. 20 is a top plan view of a cylindrical vent and screen assembly in accordance with another aspect of the disclosure.

FIG. 20A is a cross-sectional view of the screen of FIG. 20.

FIG. 21 is a perspective view of the cylinder of FIG. 20 attached to the vent and enclosure of FIG. 19.

FIG. 21A is a perspective view of the assembly of FIG. 21 attached on an attic or roof vent.

FIG. 22 is a perspective view of a concentric screen and the screen forming mold in accordance with another aspect of the disclosure.

FIG. 23 is a perspective view of the concentric screen of FIG. 22.

FIG. 23A is a cross-sectional view of the screen of FIG. 23.

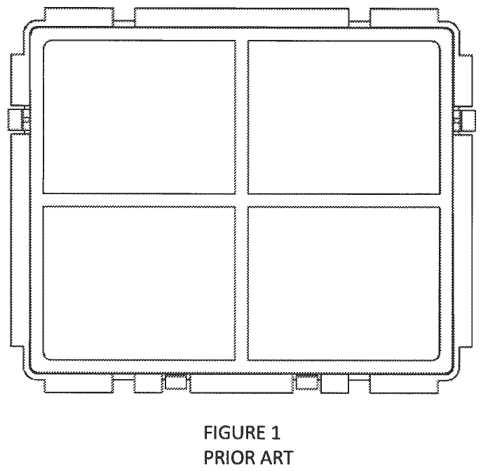

### DETAILED DESCRIPTION OF THE DISCLOSURE

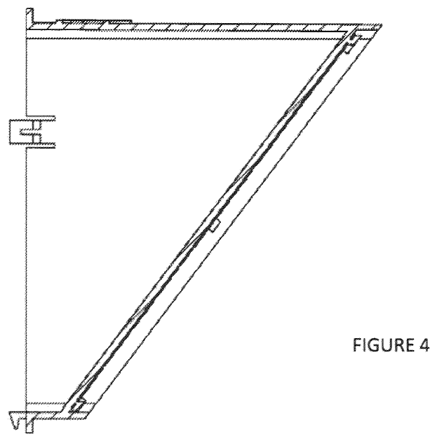

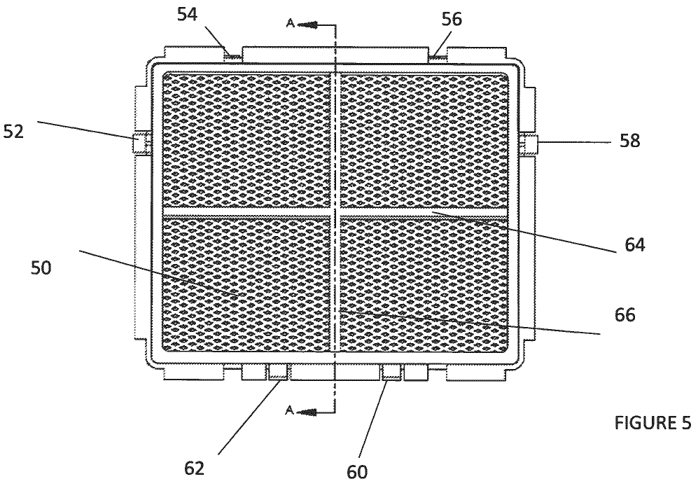

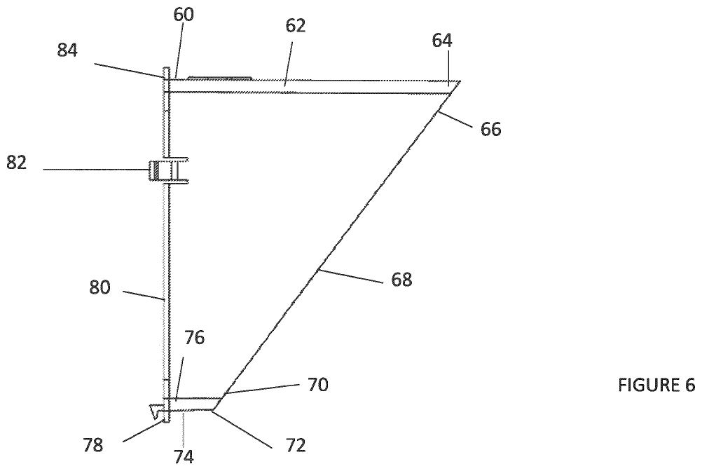

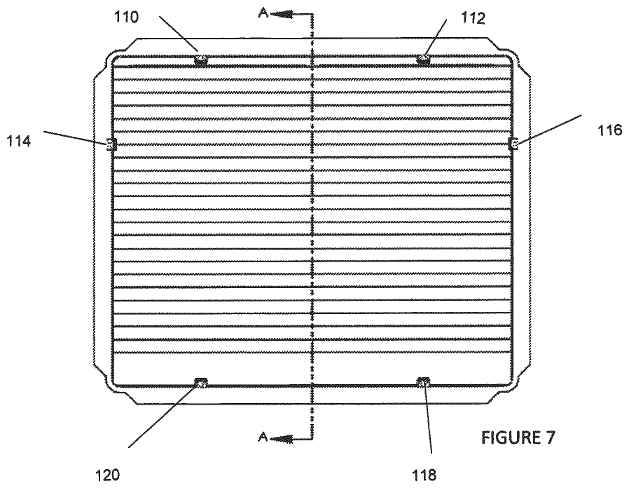

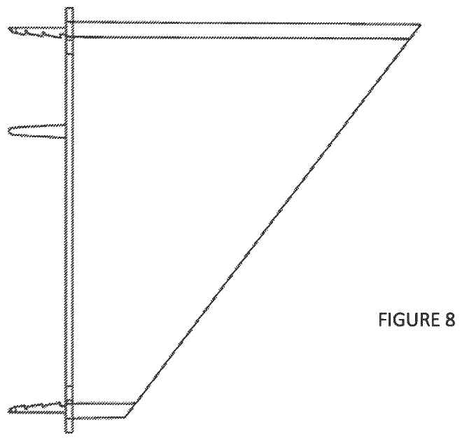

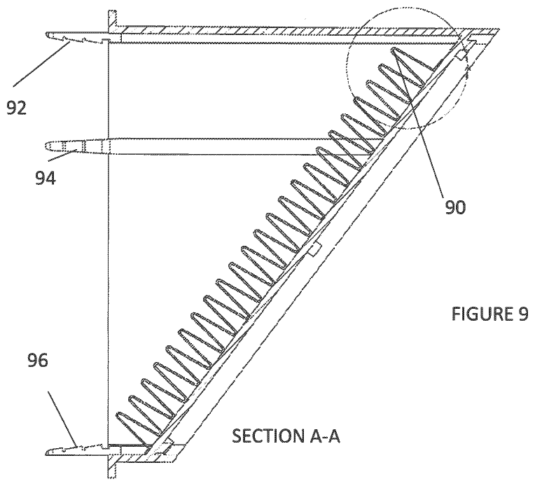

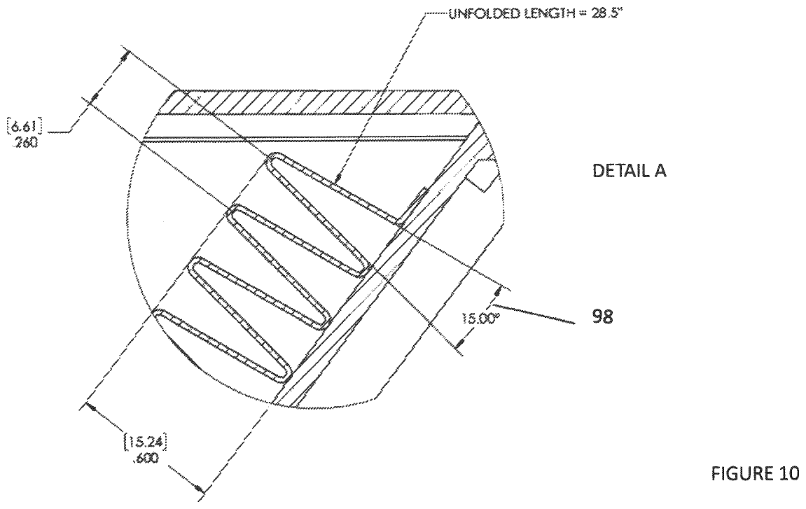

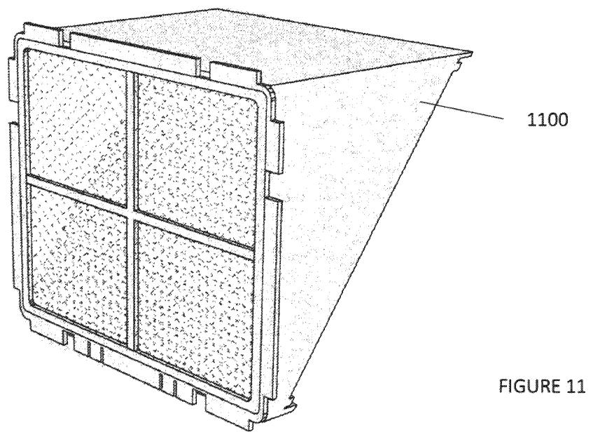

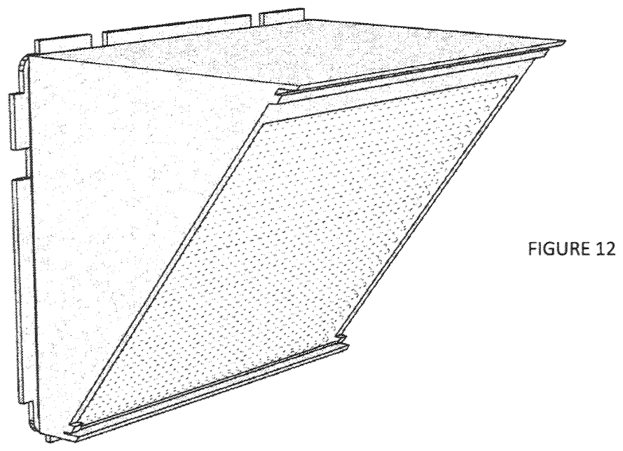

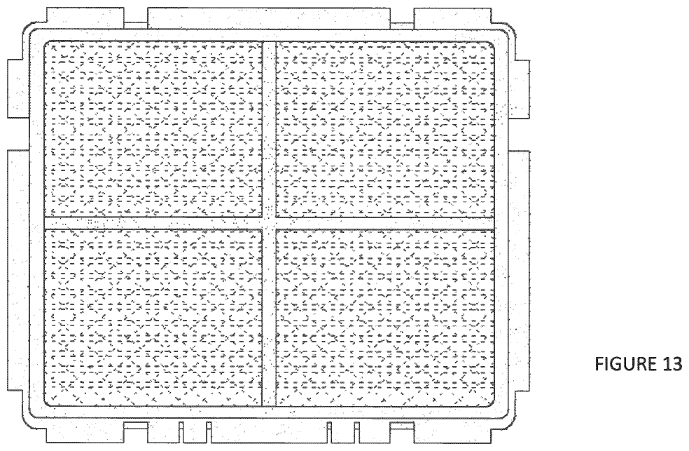

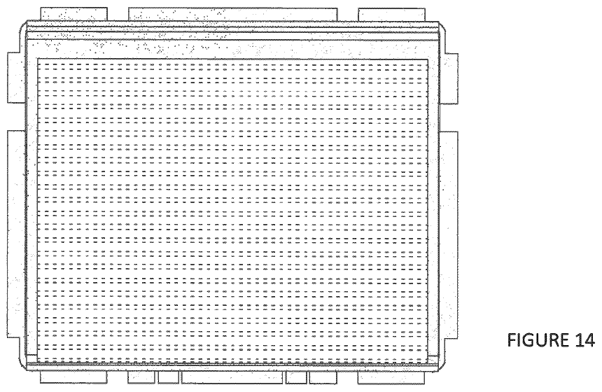

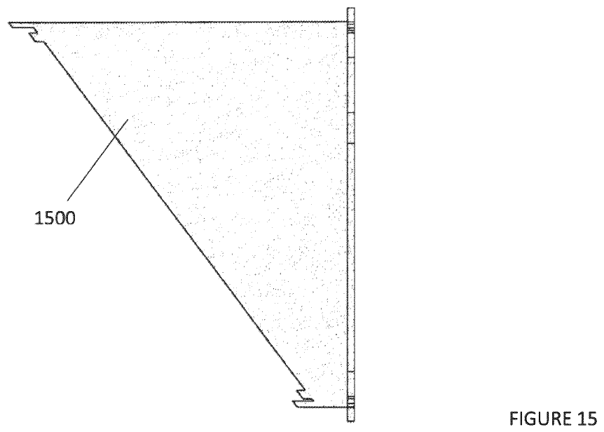

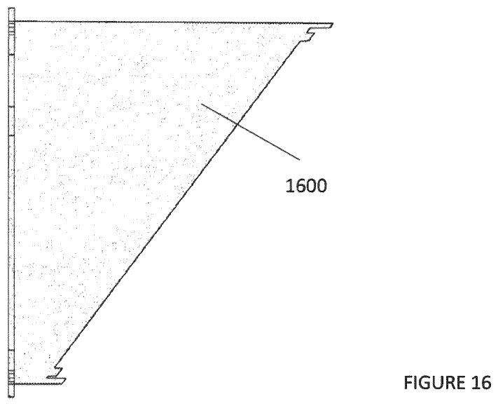

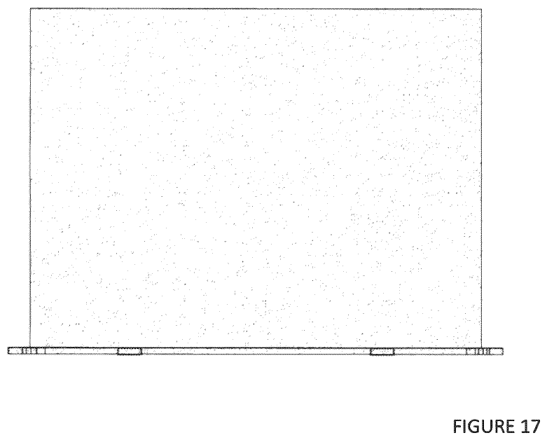

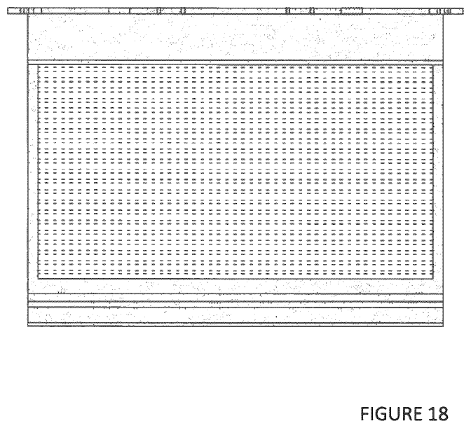

According to one aspect of the present invention, a high-flow ember shield building ventilator is provided. As shown in FIGS. 4-18, there may be a high-flow ember shield building ventilator, comprising: a substantially trapezoidal outer frame portion (1100) with a long side (62), a short side (74), a substantially vertical front side (80) and opposing angled sides (1500 and 1600). The long side (62) has a first long side end (60) and a second long side end (64), the short side (74) has a first short side end (76) and a second short side end (72), the substantially vertical front side (80) has a first substantially vertical front side end (84) and a second substantially vertical front side end (78), the angled side (68) has a first angled side end (66) and a second angled side end (70). The second long side end (64) is in communication with the first angled side end (66), the second angled side end (70) is in communication with the second short side end (72), the first short side end (76) is in communication with the second substantially vertical front side end (78) and the first substantially vertical front side end (84) is in communication with the first long side end (60). It is noted that this forms one side of the opposing angled side as shown in FIG. 16. As would be appreciated by one of ordinary skill in the art, the opposing side as shown in FIG. 15 would be mirror image of FIG. 16 in order to form the three dimensional substantially trapezoidal outer frame portion (1100).

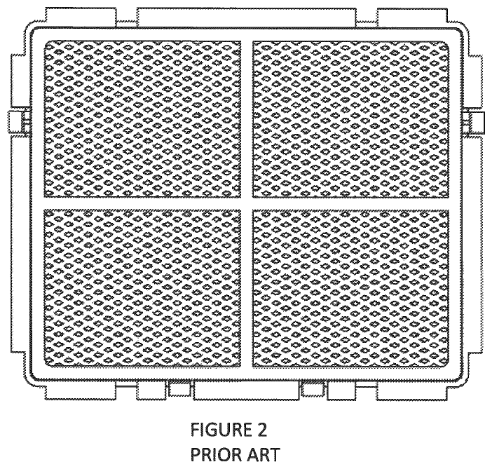

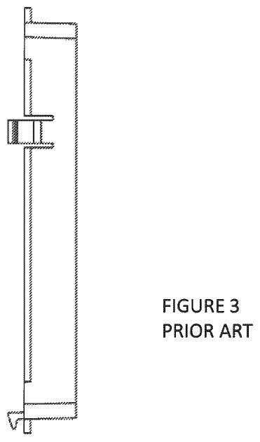

There may be at least one attachment clip (82, 52, 54, 56, 58, 60, 62)) for inserting the ventilator into a frame. The attachment clips may be on at least one of the long side (62), substantially vertical front (80) and short side (74). The substantially vertical front side has cross members (64, 66). The cross members may be perpendicular to form a plus shape (+). There may also be an expanded aluminum sheet (50) with openings retained behind the cross members (64, 66). The openings may be diamond shaped. This provides greater ventilation while protecting embers from entry. The openings are between 7 and 7.5 inches squared including the cross members, preferably substantially 7.30 inches squared including the cross members. As can been seen in comparing FIG. 5 to prior art FIG. 2, there are a greater number of smaller openings. This provides superior blocking passage to small airborne particles like glowing embers from a forest fire. In addition to its usefulness in preventing entry of hot embers, the invention also has application in enhancing the performance of attic, roof and wall cavity ventilation systems, allowing greater air flow for dissipating excess heat and for drying and moisture elimination than current profiles now in use, whether such systems use static or powered ventilation.

There may be a folded metal insert (90) between the first angled side end (66) and the second angled side end (70). The folded metal insert may be a metal screen.

A screen or mesh also prevents intrusion of insects or rodents. The folded metal insert may have folds at a substantially 15 degree angle (92). There may also be at least one vertical support (e.g. 92, 94, 96). According to one embodiment, there are two vertical supports (70, 72) in communication with the long side, two vertical supports (80, 74) in communication with each of the opposing angled sides and two vertical supports (76, 78) in communication with the short side.

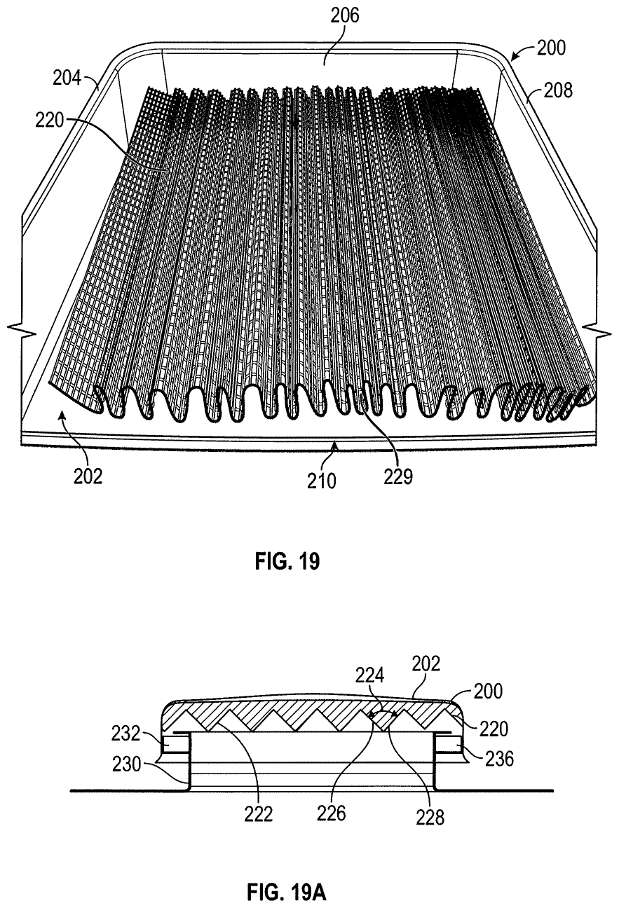

Referring to FIGS. 19-21, a high flow ember shield for an attic exhaust fan in accordance with another aspect of the disclosure is shown.

The shield shown in FIGS. 19-21 can be used with a roof or attic exhaust system. It can be applied for shielding embers or debris, but is not limited to this application.

Referring to FIG. 19, the shield includes a square or rectangular shaped enclosure or frame 200 which has a bottom wall 202, and side walls 204,206,208,210 forming an enclosure for a folded metal insert or screen 220.

Referring to FIG. 19A, a cross-sectional view of the folded metal insert showing the folds 222 of the insert is shown. An angle 224 is formed between adjacent angled portions 226,228 of the screen such as 15 degrees although other angles are contemplated by the disclosure. The insert has a plurality of square vent openings 229 of ⅛ inches or less to allow air flow and prevent embers or other debris from entering the vent. The openings 229 are effective to block embers and the screen 220 can be placed on top of a standard flat screen.

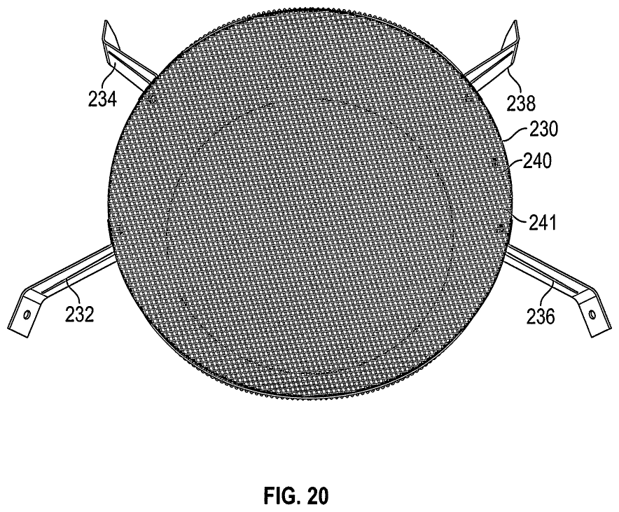

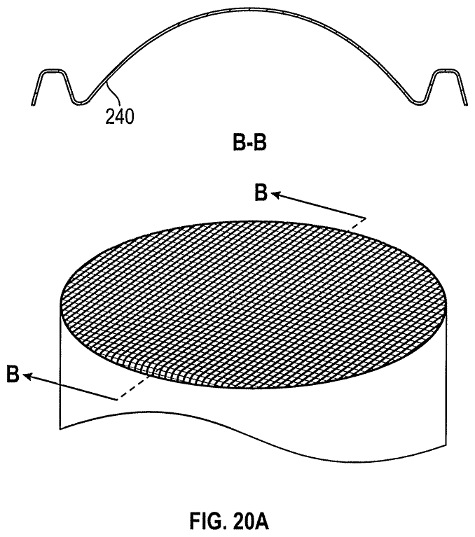

Referring to FIG. 20, a cylindrical frame 230 having four spaced about attachment arms 232,234,236,238 using with a vent screen 240 having an outward curvature attached thereon.

FIGS. 20A shows a cross-sectional view of the screen 240. Screen 240 also has square shaped openings 241 of ⅛ inch or less for preventing embers or debris from entering the vent.

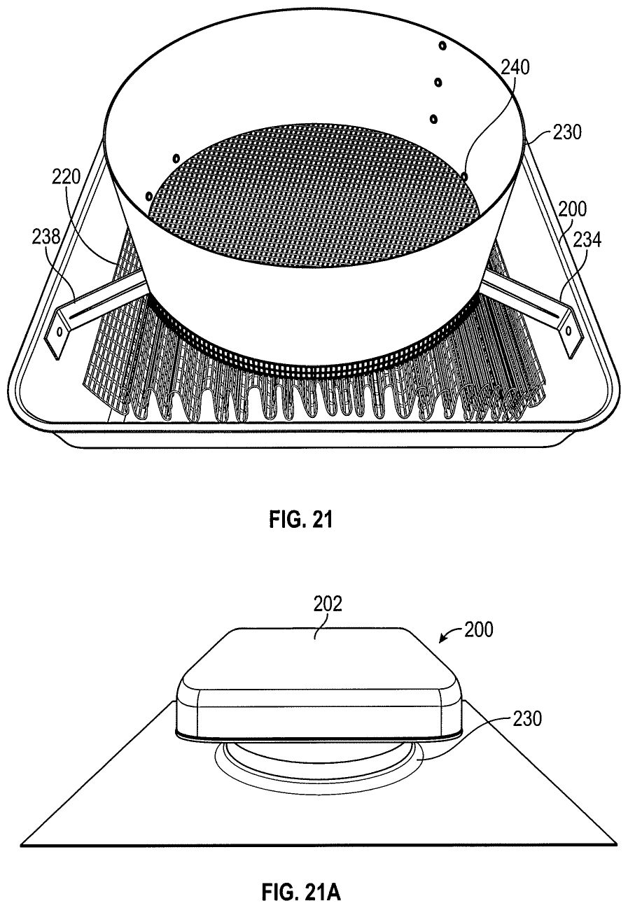

The frame 230 and screen 240 are mounted to frame 200 and is attached to frame 200 via arms 232,234,236,238 using appropriate fasteners. (see FIG. 21)

The entire assembly show in FIG. 21 is mounted to an exhaust fan opening in a roof or attic (see FIG. 21A) to also prevent embers from entering the exhaust ventilator system, as well as enhancing the performance of the attic or roof ventilation system allowing fan greater air flow or increased Net Free Area (NFA) for transporting excess heat and for drying and moisture elimination.

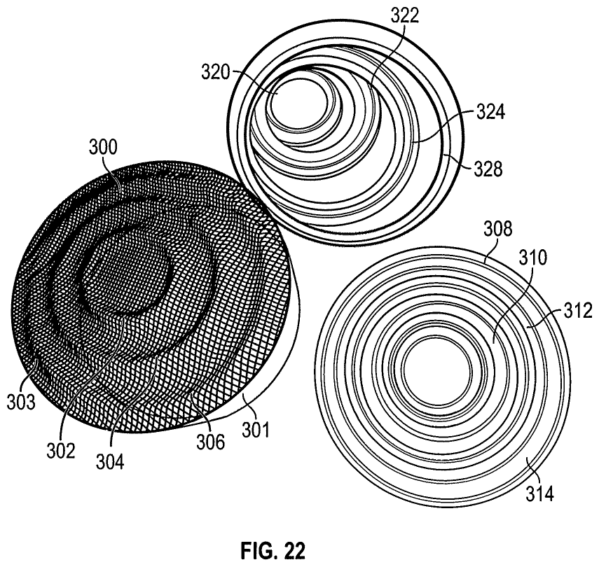

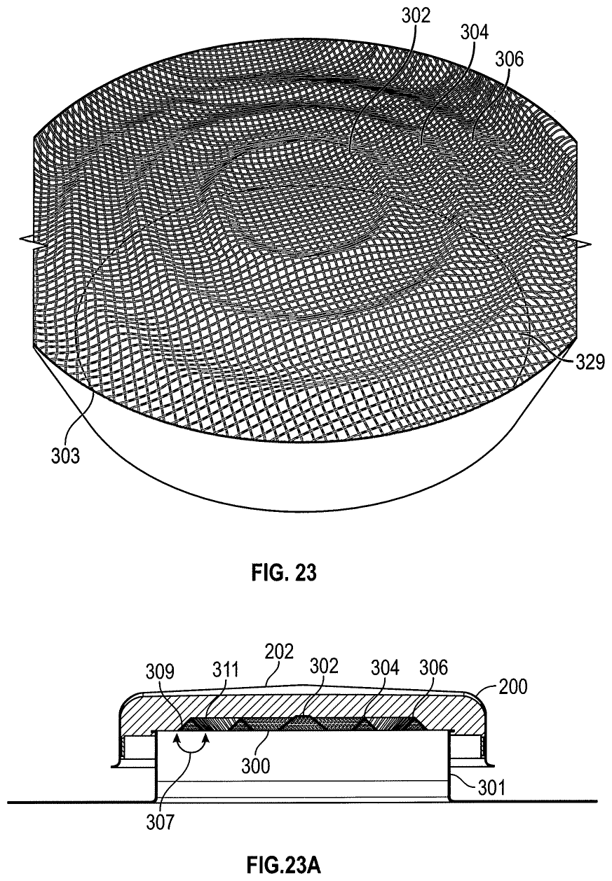

Referring now to FIGS. 22, 23 and 23A a concentric screen 300 and cylindrical frame 301 in accordance with another preferred embodiment of the disclosure are shown.

Screen 300 is formed with a plurality of concentric rings 302,304,306 of the mesh 303 by placing the screen over a mold 308 with concentric rings 310,312, and 314.

The screen 300 is placed on mold 308 and other concentric rings 320,322,324,328 are placed over the screen pressing the screen into the mold 308 thereby forming the concentric ring pattern of screen 300 (see FIG. 23). The rings are applied from the middle outward so ring 320 is placed on the screen first followed by rings 322,324 and 328.

The screen 300 also has square vent openings 329 of ⅛ inch or less. The concentric ring pattern of the mesh 307 increases the Net Free Area (NFA) and improves air flow as well as preventing embers or other debris from entering the screen. Specifically, the concentric ring configuration is 55 square inches NFA, in comparison to a standard flat screen which has 49 square inch NFA. That is by providing concentric rings of screen, the number of square openings 329 fan increases thereby increasing air flow thus increasing NFA. A cross-sectional view of the screen 300 is shown in FIG. 23A. Screen 300 can be used in configuration with a flat screen or a folded insert screen such as 220, to provide improved ember blockage as well as increased NFA.

The screen concentric rings 302,304,306 have an angle 307 formed between adjacent portions 309,311 such as 15 degrees or 30 degrees or more. Ring 304 has a greater diameter than ring 302, while ring 306 has a greater diameter than ring 304.

It should be understood that the foregoing relates to preferred embodiments of the disclosure and that modifications may be made without departing from the spirit and scope of the disclosure as set forth in the following claims.

1. A high-flow ember shield building ventilator for use with roof or attic exhaust openings, comprising:
a substantially rectangular outer frame portion with four side walls and a bottom wall; a folded screen insert inserted into an opening of said frame portion formed by said
side walls and said bottom wall;
a cylindrical frame having a screen installed thereon, wherein said cylindrical frame and said screen are mounted onto said rectangular frame portion and over said folded metal insert.

2. A high-flow ember shield building ventilator as in claim 1, further comprising at least one attachment clip for mounting said cylindrical frame onto said rectangular frame.

3. A high-flow ember shield building ventilator as in claim 2, wherein said at least one attachment clip comprises four spaced apart attachment clips.

4. The high-flow ember shield ventilator of claim 1,
wherein said folded screen insert has a plurality of folds at a substantially 15 degree angle.

5. The high-flow ember shield ventilator of claim 1, wherein said folded screen insert is made of metal.

6. The high-flow ember shield ventilation of claim 1,
wherein said folded screen insert has a plurality of openings of about ⅛ inch in size.

7. The high-flow ember shield of claim 1, wherein said screen has an outward curvature.

8. The high-flow ember shield of claim 1, wherein said screen has a mesh comprising openings of about ⅛ inches in size.

9. The high-flow ember shield of claim 8, wherein said screen is made of metal.

10. A high-flow ember shield configuration for use with a roof or attic exhaust ventilation system comprising:
a cylindrical frame;
a screen insert formed of concentric rings of mesh;
wherein said screen is inserted into said cylindrical frame for preventing embers and other debris entering the exhaust ventilation system.

11. The high-flow ember shield of claim 10,
wherein said shield comprises a first ring, a second ring and a third ring which are concentric to each other.

12. The high-flow ember shield of claim 11, wherein said second ring has a diameter greater than said first ring.

13. The high-flow ember shield of claim 12, wherein said third ring has a diameter greater than said second ring.

14. The high-flow ember shield of claim 10, wherein said screen insert is made of metal.

15. The high-flow ember shield of claim 10, wherein said concentric rings are formed by adjacent portions of said screen insert having an angle formed therebetween.

16. The high-flow ember shield of claim 15, wherein said angle is about 15 degrees.
